(19) United States
(12) Patent Application Publication
(10) Pub. No.: US 2024/0259960 A1
(43) Pub. Date: Aug. 1, 2024

(54) INDICATION TO REDUCE TRANSMISSION POWER

(71) Applicant: QUALCOMM Incorporated, San Diego, CA (US)

(72) Inventors: Idan Michael HORN, Hod Hasharon (IL); Yehonatan DALLAL, Kfar Saba (IL); Shay LANDIS, Hod Hasharon (IL); Amit BAR-OR TILLINGER, Tel-Aviv (IL)

(21) Appl. No.: 18/160,772

(22) Filed: Jan. 27, 2023

(51) Int. Cl. H04W 52/36; H04L 1/00; H04W 52/52

(52) U.S. Cl. CPC H04W 52/367; H04L 1/0003; H04W 52/52

(57) ABSTRACT

Various aspects of the present disclosure generally relate to wireless communication. In some aspects, a user equipment (UE) may receive a communication with a received power that satisfies a threshold. The UE may transmit an indication indication to reduce a transmission power based at least in part on the received power satisfying the threshold. Numerous other aspects are described.

### FIELD OF THE DISCLOSURE

Aspects of the present disclosure generally relate to wireless communication and to techniques and apparatuses for an indication to reduce transmission power.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a communication with a received power that satisfies a threshold. The method may include transmitting a request indication to reduce a transmission power based at least in part on the received power satisfying the threshold.

Some aspects described herein relate to a method of wireless communication performed by a network node. The method may include transmitting a first communication with a first transmission power. The method may include receiving a request indication to reduce a transmission power based at least in part on a received power, at a UE, satisfying a threshold. The method may include transmitting a second communication with a second transmission power that is less than the first transmission power.

Some aspects described herein relate to a UE for wireless communication. The user equipment may include a memory and one or more processors coupled to the memory. The one or more processors may be configured to receive a communication with a received power that satisfies a threshold. The one or more processors may be configured to transmit a request indication to reduce a transmission power based at least in part on the received power satisfying the threshold.

Some aspects described herein relate to a network node for wireless communication. The network node may include a memory and one or more processors coupled to the memory. The one or more processors may be configured to transmit a first communication with a first transmission power. The one or more processors may be configured to receive a request indication to reduce a transmission power based at least in part on a received power, at a UE, satisfying a threshold. The one or more processors may be configured to transmit a second communication with a second transmission power that is less than the first transmission power.

Some aspects described herein relate to a non-transitory computer-readable medium that stores a set of instructions for wireless communication by a UE. The set of instructions, when executed by one or more processors of the UE, may cause the UE to receive a communication with a received power that satisfies a threshold. The set of instructions, when executed by one or more processors of the UE, may cause the UE to transmit a request indication to reduce a transmission power based at least in part on the received power satisfying the threshold.

Some aspects described herein relate to a non-transitory computer-readable medium that stores a set of instructions for wireless communication by a network node. The set of instructions, when executed by one or more processors of the network node, may cause the network node to transmit a first communication with a first transmission power. The set of instructions, when executed by one or more processors of the network node, may cause the network node to receive a request indication to reduce a transmission power based at least in part on a received power, at a UE, satisfying a threshold. The set of instructions, when executed by one or more processors of the network node, may cause the network node to transmit a second communication with a second transmission power that is less than the first transmission power.

Some aspects described herein relate to an apparatus for wireless communication. The apparatus may include means for receiving a communication with a received power that satisfies a threshold. The apparatus may include means for transmitting a request indication to reduce a transmission power based at least in part on the received power satisfying the threshold.

Some aspects described herein relate to an apparatus for wireless communication. The apparatus may include means for transmitting a first communication with a first transmission power. The apparatus may include means for receiving a request indication to reduce a transmission power based at least in part on a received power, at a UE, satisfying a threshold. The apparatus may include means for transmitting a second communication with a second transmission power that is less than the first transmission power.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of devices using optical wireless communication, in accordance with the present disclosure.

FIG. 5 is a diagram of an example associated with an indication from a UE to reduce transmission power, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

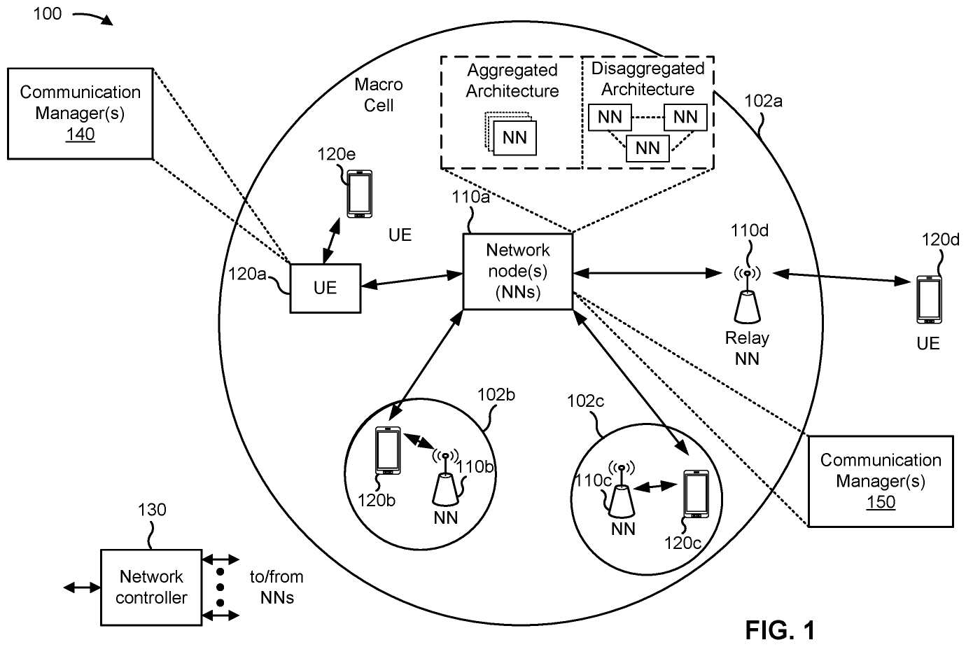

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a communication with a received power that satisfies a threshold; and transmit a request indication to reduce a transmission power based at least in part on the received power satisfying the threshold. Additionally, or alternatively, the communication manager 140 may perform one or more other operations described herein.

In some aspects, the network node 110 may include a communication manager 150. As described in more detail elsewhere herein, the communication manager 150 may transmit a first communication with a first transmission power; receive a request indication to reduce a transmission power based at least in part on a received power, at a UE, satisfying a threshold; and transmit a second communication with a second transmission power that is less than the first transmission power. Additionally, or alternatively, the communication manager 150 may perform one or more other operations described herein.

As indicated above, FIG. 1 is provided as an example. Other examples may differ from what is described with regard to FIG. 1.

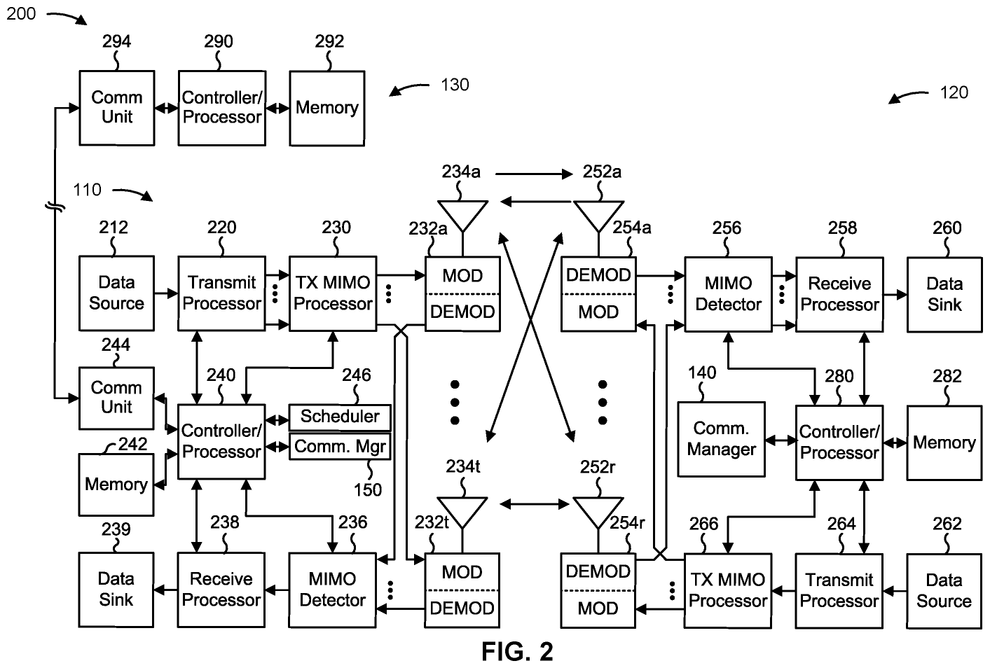

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

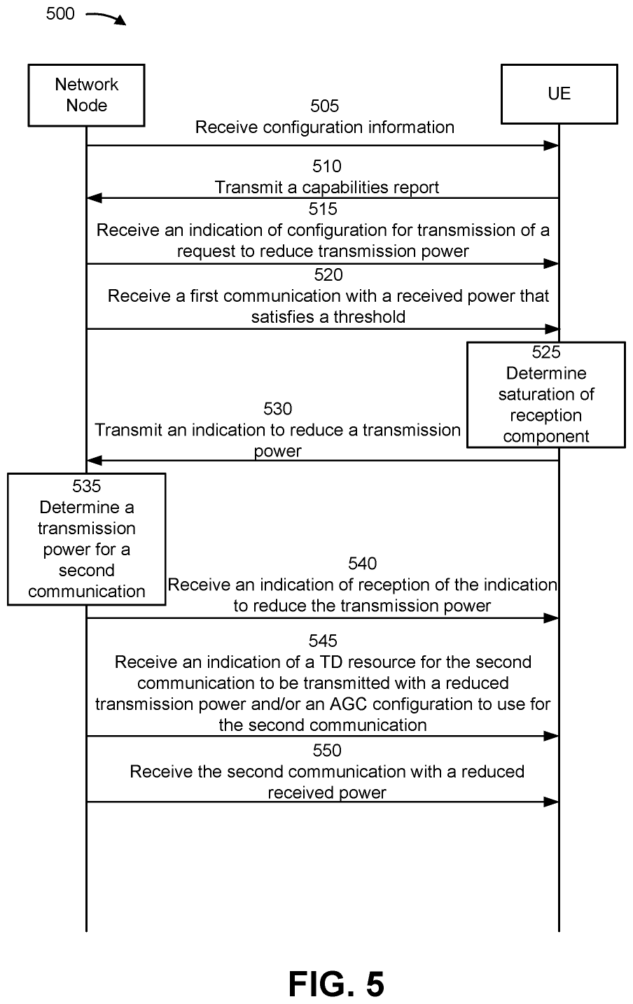

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

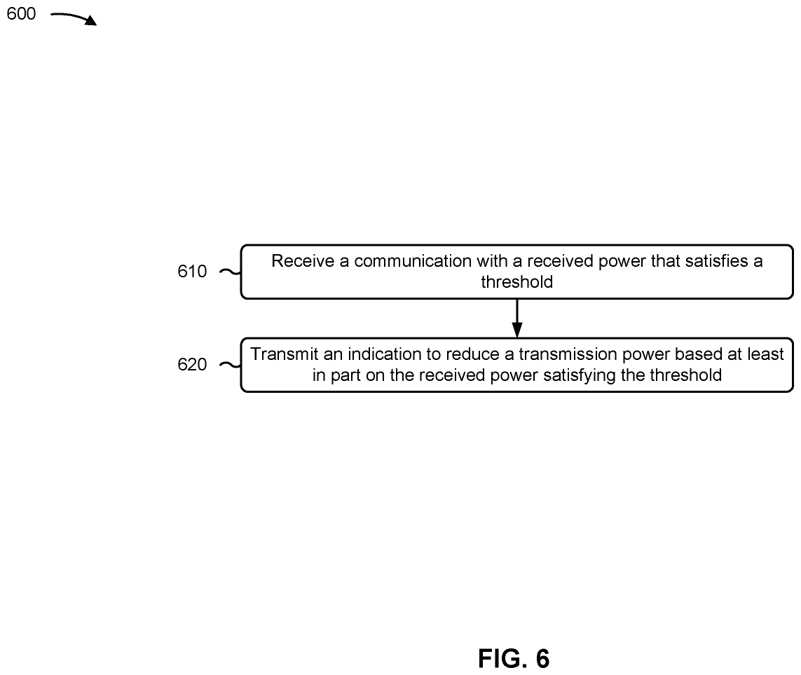

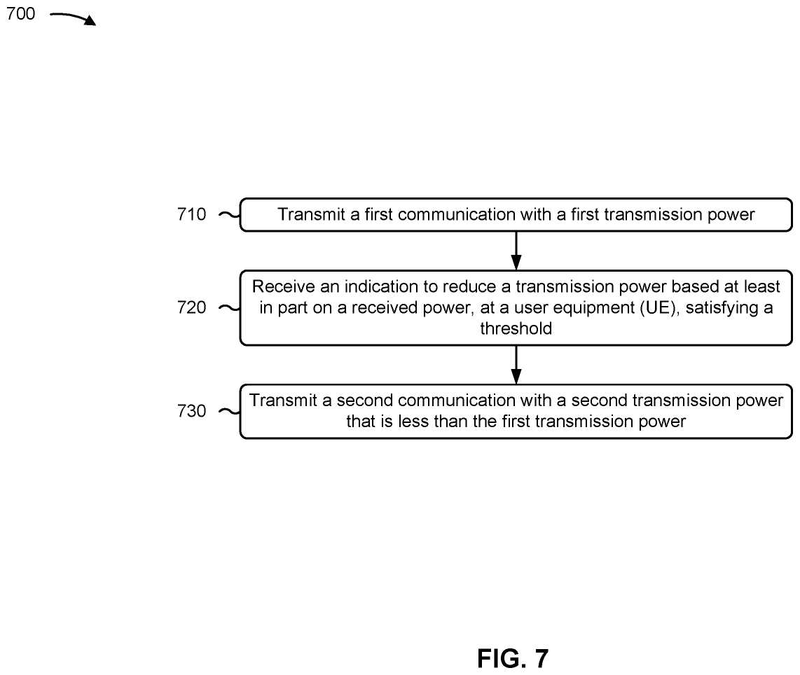

The controller/processor 240 of the network node 110, the controller/processor 280 of the UE 120, and/or any other component(s) of FIG. 2 may perform one or more techniques associated with an indication (e.g., a request) to reduce transmission power, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE includes means for receiving a communication with a received power that satisfies a threshold; and/or means for transmitting an indication (e.g., a request) indication to reduce a transmission power based at least in part on the received power satisfying the threshold. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting a first communication with a first transmission power; means for receiving an indication (e.g., a request) indication to reduce a transmission power based at least in part on a received power, at a UE, satisfying a threshold; and/or means for transmitting a second communication with a second transmission power that is less than the first transmission power. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

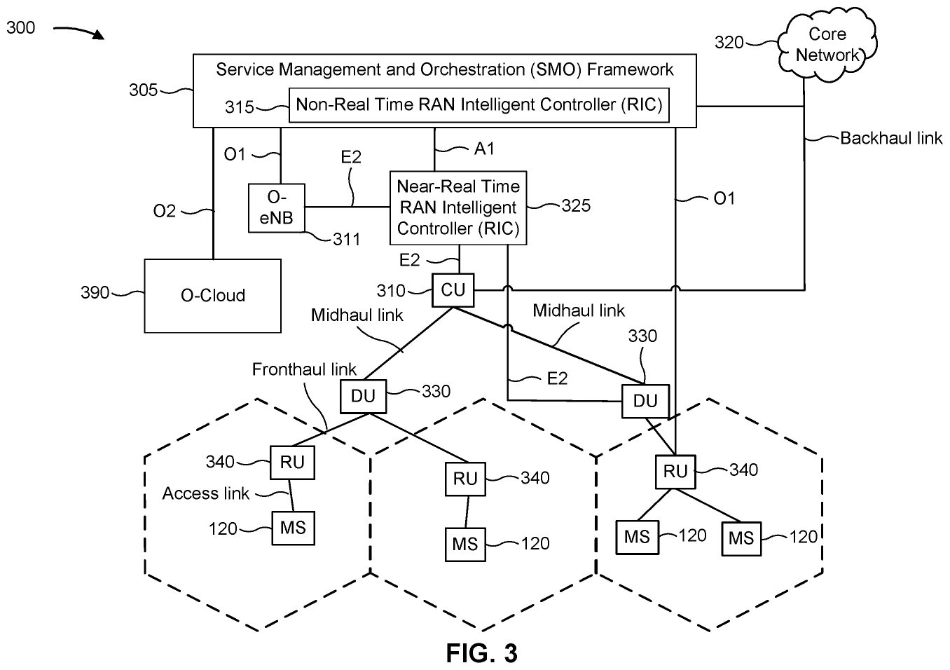

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

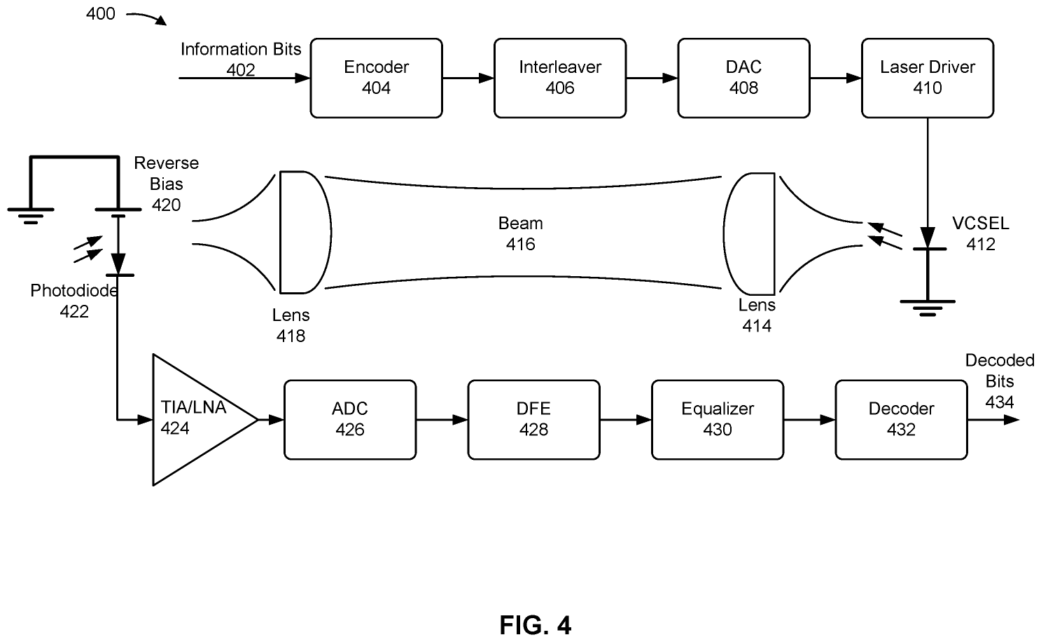

FIG. 4 is a diagram illustrating an example 400 of devices using optical wireless communication (OWC), in accordance with the present disclosure. As shown in example 400, a transmitting device (e.g., a network node 110) may transmit a communication using optical signaling, and a receiving device (e.g., a UE 120) may receive the communication using an optical receiver and reception chain.

As shown in FIG. 4, the transmitting device may receive information bits 402 for transmission to the receiving device. For example, the transmitting device may generate the information bits 402 locally and/or may receive the information bits 402 from another network node and/or a computing device outside of the network (e.g., an application server).

The transmitting device may provide the information bits 402 to an encoder 404 that applies coding to the information bits 402. The coding may reduce a payload of a communication that includes the information bits 402, may add redundancy bits, and/or may provide security features to the information bits.

The transmitting device may provide the information bits 402 to an interleaver 406 to diversify bit signaling throughout a frequency domain of a communication that is to include the information bits. In this way, the interleaver 406 may improve decoding of the communication.

The transmitting device may provide the information bits 402 to a digital to analog converter (DAC) 408 to convert the information bits 402 to an analog domain for transmission via physical hardware (e.g., an antenna or an optical emitter). In this way, the information bits 402 may be converted to a modulated signal in the analog domain.

In example 400, the signaling carrying the information bits 402 may be provided to a laser driver 410 to generate a laser-based signal for transmission over the air. The laser driver 410 may provide the modulated signal to a laser, such as the vertical-cavity surface-emitting laser (VCSEL) 412 shown in example 400. The laser may transmit the modulated signal over the air.

The transmitting device may provide a lens 414 to collimate the modulated signal emitted from the laser. In this way, the modulated signal may have increased range based at least in part on having a focused power in a direction.

The modulated signal may travel over the air in a beam 416 in a direction of the receiving device. The receiving device may receive the modulated signal using a lens 418 (e.g., a receiving lens) and may apply a reverse bias 420 to convert an over-the-air signal into an electrical signal. The receiving lens 418 may focus the modulated signal to a photodiode 422 that detects light from the modulated signal.

The photodiode 422 may provide a signal to a transimpedance amplifier (TIA) and/or a low noise amplifier (LNA) 424. The TIA and/or the LNA 424 may amplify an output of the photodiode 422 (e.g., a current output) for further processing. The TIA and/or the LNA 424 may provide the signal to an analog to digital converter (ADC) 426 to convert the signal from an analog signal received from the TIA and/or the LNA 424 into a digital signal for further processing. The digital signal may be provided to a digital front end 428 to process the signal (e.g., digital baseband conversion and/or other digital operations). The digital signal may be provided to one or more additional processing components (e.g., an equalizer 430) before being provided to a decoder 432. The decoder 432 may decode the digital signal to identify the information bits 402 from the digital signal. The decoder 432 may output decoded bits 434. The decoded bits 434 may be the same as the information bits 402 or may have errors from the information bits 402 that satisfy an error threshold.

In some networks, the receiving device may be configured with a limited automatic gain control (AGC) component to conserve power and computing resources. However, the limited AGC may become saturated if a received power of a communication is too high (e.g., with a received power satisfying a threshold associated with saturation). Total saturation may occur when an amplified signal (e.g., after operation by a power amplifier) has a same power as an input signal (e.g., input to the power amplifier). This may occur when an output signal has a power limit that is the same as the input signal. Partial saturation may occur when a portion of the input signal (e.g., subset of one or more subcarriers of the input signal) has a same power as the power limit of the output signal. Additionally, or alternatively, partial saturation may occur when a first portion of the input signal is amplified by a different amount than a second portion (e.g., with a different linear increase of power and/or a different proportional increase of power). Saturation, as used herein, may include total saturation of partial saturation. For example, saturation may be based at least in part on a compression of an amplified signal (e.g., a reduction in differences in power at different subcarriers after amplification compared to before compression. In some aspects, saturation may be based at least in part on satisfaction of a threshold of compression. For example, a threshold associated with saturation may be based at least in part on an output 1 dB compression point.

In some aspects, the threshold associated with saturation may be associated with a received power (e.g., an input power to a power amplifier) that correspond to a level of saturation that reduces throughput of communications. When a downlink communication is at the threshold, a received power and saturation may be optimized for maximum throughput (e.g., based at least in part on saturation and/or rank, among other examples). When a downlink communication is below the threshold, saturation may be avoided and the received power may lower than a maximum (e.g., which may reduce support for an optimized MCS and/or rank). In some aspects, the UE may target a received power that is below the threshold to reduce a likelihood of saturation at an expense of received power.

In some networks, the receiving device may not have an AGC (e.g., in an OWC network and/or a free space optics (FSO) communication network). Additionally, or alternatively, the TIA and/or the LNA may become saturated if the received power satisfies a threshold (e.g., the received power is too high). In this case, the receiving device may report support for an MCS that is less than what would be supported if the AGC and/or an amplifier (e.g., the TIA and/or the LNA) were not saturated. If the transmitting device uses the MCS that is supported, the transmitting device and the receiving device may communicate with reduced spectral efficiency. If the transmitting device increases transmission power to improve support for an increased MCS, the saturation may worsen and the receiving device may support an even lower MCS, which may reduce spectral efficient even further and unnecessarily consume power resources of the transmitting device used to increase transmission power. Additionally, or alternatively, avoiding saturation may improve throughput of communications based at least in part on increasing MCS and/or supporting an increased rank among other examples.

As indicated above, FIG. 3 is provided as an example. Other examples may differ from what is described with regard to FIG. 3.

In some aspects described herein, a UE (e.g., the receiving device of FIG. 4) may transmit an indication of reception component saturation and/or a request to reduce transmission power by a network node (e.g., an RU, a TRP, and/or a base station associated with the network node). For example, the UE may receive a first communication that saturates one or more reception components of the UE. The UE may transmit an indication (e.g., a request) to the network node to reduce transmission power. The indication may indicate an amount to reduce the transmission power and/or that the indication is based at least in part on saturation of the one or more reception components of the UE. The network node may reduce transmission power for transmission of a second communication subsequent to reception of the indication to reduce transmission power.

In some aspects, the first communication and the second communication may be an FSO-base communication or an RF communication (e.g., a sub THz communication, an FR1, or an FR2 communication, among other examples). In some aspects, saturation may occur based at least in part on the UE having a reception component that has limited performance. For example, the UE may include an extended reality (XR) device, an Internet of Things (IoT) device, a device with a limited ADC, a limited effective number of bits (ENOB), or a limited capability for AGC, among other examples.

Based at least in part on reducing saturation of the one or more reception components of the UE, the UE may support an increased MCS, which may conserve network resources, and the network node may conserve power resources that may have otherwise been used to increase transmission power in an attempt to increase the MCS.

In an example, the UE may reception a downlink communication with, for example, a 40 dBm effective isotropic radiated power (EIRP) that saturates the UE one or more reception components (e.g., RF components). This saturation may cause the UE to support a reduced rank and/or MCS. The UE may transmit an indication to the network node to indicate a request to reduce the network node transmission power (e.g., EIRP) by 20 dB for a subsequent downlink communication. In some aspects, the UE may indicate the requested reduction in transmission power based at least in part on a configured granularity for the indication (e.g., configured by the network node and/or indicated in a communication protocol). In some aspects, the UE may indicate a beam, a channel, an MCS, a component carrier (e.g., a component carrier for which communications are saturated and/or a component carrier that causes saturation that damages communications of a different component carrier, such as by reducing signal-to-noise ratio (SNR)), and/or a beam width associated with the indication to reduce the transmission power (e.g., the UE may not want to reduce transmission power for different channels, different beams, and/or different beam widths, among other examples).

The network node may transmit an indication of acceptance of the requested reduction of transmission power and may reduce the EIRP to 20 dBm on the subsequent downlink communication. If the one or more UE reception components are still saturated, the UE may transmit an indication to the network node to request another power reduction.

In some aspects, the UE may transmit a report to the network node of a limited AGC at the UE and/or a risk that UE reception components may be saturated based at least in part on a received power satisfying a threshold. The report may indicate whether the UE uses an AGC for reception and, if an AGC is used, a range in dBm or a span from a maximal power of the AGC. The UE may further indicate an AGC configuration duration. For example, if the AGC duration is long and there is an expectation of a change in the network node power (e.g., based at least in part on the report), the network node may transmit an indication of the acceptance of the report to enable the UE to prepare the AGC in advance.

In an example process, the UE may transmission an indication of AGC parameters of the UE (e.g., at connection establishment the UE). The UE may receive a downlink communication that saturates one or more UE reception components. The UE may estimate whether the one or more UE reception components are saturated and a power reduction that is likely to avoid saturation for a subsequent communication.

The estimation may be based at least in part on received maximal energy and an error vector magnitude (EVM) measured on the data or on a dedicated low cost RF components for measuring high power energy.

The UE may transmit an indication (e.g., a request) to reduce the network node transmission power (e.g., EIRP) for a subsequent communication. In some aspects, the indication may include a requested amount of power reduction (e.g., relative to a previous downlink communication) or an explicit indication of the transmission power for the subsequent communication. In some aspects, the requested amount of power reduction may be based at least in part on differentiation from a most recent physical downlink shared channel (PDSCH), synchronization signal block (SSB), tracking reference signal (TRS), physical downlink control channel (PDCCH), or other communication. In some aspects, the indication of the requested amount of power may be indicated in a dB scale. The amount may be an estimated amount of power reduction to target a middle AGC span area to increase reliability or maximal acceptable power to optimize a capacity (e.g., which may be configured by the network node).

In some aspects, the UE may transmit the indication using a MAC control element (CE), a RRC message, and/or a channel state information (CSI) report, among other examples.

The network node may accept the indication to reduce the transmission power and may reduce the EIRP. In some aspects, the network node may reduce the transmission power as indicated by the UE or by a different amount. In some aspects, the network node may indicate (e.g., using a single bit in a MAC CE message or RRC message) if the power reduction matches the amount requested by the UE. In some aspects, the network node may transmit an indication of a time and/or slot index of a first subsequent communication having the power reduction applied. In this way, the UE may prepare the AGC for the power reduction in synchronization with implementation of the power reduction by the network node.

In case the one or more UE reception components are still saturated when receiving the subsequent communication, the UE may transmit an additional indication to request another power reduction.

Although examples describe the UE indicating saturation of the one or more UE reception components, other techniques may be used for the network node to determine that saturation has occurred and reducing the transmission power may support increased MCS. For example, the network node may increase transmission power in an attempt to assist the UE in supporting an increased MCS. The UE may transmit an indication of a reduced MCS based at least in part on the increased transmission power saturating the one or more UE reception components. The network node may determine to reduce the transmission power based at least in part on increased transmission power causing support for a reduced MCS by the UE. The network node may transmit a subsequent communication with a reduced transmission power and, based at least in part on receiving an indication of support by the UE for an increased MCS, the network node may determine that the increased transmission power saturated the one or more UE reception components. The network node may test a further reduction in transmission power to identify a transmission power that balances coverage with avoiding saturation of the one or more UE reception components. In some aspects, the network node may perform this described process based at least in part on receiving an indication from the UE (e.g., at connection establishment) of a risk of saturation of the one or more UE reception components.

In some aspects, the network node may reduce an EIRP based at least in part on reducing a transmitted output power of a network node transmission array (e.g., antennas) and/or reduce a directivity gain (e.g., increase a beam width) and by that increase mobility support for the UE.

In some aspects, the network node may provide the indication to reduce transmission power to a neighbor cell that may be causing interference that increases saturation of the one or more UE reception components.

FIG. 5 is a diagram of an example 500 associated with an indication from a UE to reduce transmission power, in accordance with the present disclosure. As shown in FIG. 5, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 5.

In some aspects, the UE may include an OWC device, an XR display device or input device, and/or an IoT device, among other examples. In some aspects, the UE may have limited capability for one or more of ADC, ENOB, and/or AGC, among other examples, which may be associated with communication errors when saturation occurs.

As shown by reference number 505, the network node may transmit, and the UE may receive, configuration information. In some aspects, the UE may receive the configuration information via one or more of RRC signaling, one or more MAC control elements (CEs), and/or downlink control information (DCI), among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit an indication of support for AGC, a range of AGC, and/or support for transmission of a request to reduce transmission power, among other examples. In some aspects, the configuration information may indicate one or more parameters for transmitting the request to reduce transmission power.

The UE may configure itself based at least in part on the configuration information. In some aspects, the UE may be configured to perform one or more operations described herein based at least in part on the configuration information.

As shown by reference number 510, the UE may transmit, and the network node may receive, a capabilities report. In some aspects, the capabilities report may indicate UE support for AGC, one or more parameters (e.g., a range) of AGC, and/or support for transmission of a request to reduce transmission power, among other examples. In some aspects, the capabilities report may indicate a risk of saturation and/or that when saturation occurs, MCS supported by the UE may be reduced.

In some aspects, the configuration information described in connection with reference number 505 and/or the capabilities report described in connection with reference number 510 may include multiple messages. For example, the configuration information may include a first message transmitted via a first time resource, the capabilities report may include a second message transmitted via a second time resource, and the configuration information may include a third message transmitted via a third time resource in response to the second message.

As shown by reference number 515, the UE may receive, and the network node may transmit, an indication of a configuration for transmission of a request to reduce transmission power.

As shown by reference number 520, the UE may receive, and the network node may transmit, a first communication with a received power that satisfies a threshold. For example, the received power may be too high and/or may be associated with saturation of one or more reception components of the UE.

In some aspects, the first communication may include an OWC-based communication, an XR-based communication, an IoT-based communication, a-Sub THz-based communication, and/or a communication in FR1 or FR2.

As shown by reference number 525, the UE may determine saturation of one or more reception components. For example, the UE may determine that the first communication saturated the one or more reception components based at least in part on a received power satisfying the threshold. In some aspects, the threshold may be associated with a saturation of a reception component and/or a maximum throughput for communications with the UE (e.g., based at least in part on saturation and/or rank). In some aspects, saturation of the one or more reception components is associated with support for a reduced MCS relative to an MCS that is supported when the one or more reception components are not saturated.

As shown by reference number 530, the UE may transmit, and the network node may receive, an indication (e.g., a request) to reduce a transmission power. For example, the UE may transmit the indication via one or more of MAC signaling, RRC signaling, and/or a CSI report, among other examples.

The UE may transmit the indication to reduce the transmission power based at least in part on the received power satisfying the threshold. In some aspects, the indication to reduce the transmission power may indicate that the first communication saturated one or more reception components. In some aspects, the threshold may be associated with a saturation of a reception component and/or a maximum throughput for communications with the UE. In some aspects, the maximum throughput for communications with the UE is based at least in part on one or more of the saturation of the reception component, a rank of communications, and/or received power of communications as measured at the UE, among other examples. In this way, the UE may transmit the indication to reduce the transmission power to avoid or reduce saturation of the reception component, maintain a sufficient reception power (e.g., too low reception power may reduce throughput based at least in part on a low signal-to-noise ratio (SNR)), and/or to increase maximum throughput for communications between the UE and the network node, among other examples.

In some aspects, the indication to reduce the transmission power may indicate an amount by which the UE request to reduce the transmission power. In some aspects, the amount may be indicated with a granularity (e.g., with a value selected from a finite number of candidate values) that is based at least in part on, for example, a configuration indicated by the network node and/or a communication protocol.

In some aspects, the indication to reduce the transmission power may be associated with one or more component carriers, one or more beams, one or more beam widths, one or more channels, and/or one or more MCSs.

As shown by reference number 535, the network node may determine a transmission power for a second communication. For example, based at least in part on receiving the indication to reduce the transmission power, the network node may determine to use a transmission power that is lower than a transmission power used to transmit the first communication.

In some aspects, the network node may use a reduced transmission power based at least in part on receiving an indication of an MCS supported when using a transmission power associated with the first communication or another communication. The network node may determine that, based at least in part on supported MCSs at different transmission powers, a reduced transmission power may increase MCS supported by the UE.

As shown by reference number 540, the UE may receive, and the network node may transmit, an indication of reception of the indication to reduce the transmission power. In some aspects, the network node may transmit an acknowledgment (ACK), an indication of whether the network node has adopted a requested amount of reduction of transmission power, and/or an indication of a difference between a transmission power applied to the second communication and the requested amount.

As shown by reference number 545, the UE may receive, and the network node may transmit, an indication of a time domain (TD) resource for the second communication to be transmitted with a reduced transmission power and/or an AGC configuration to use for the second communication.

As shown by reference number 550, the UE may receive, and the network node may transmit, the second communication with a reduced power (e.g., reduced transmission power at the network node and a reduced reception power at the UE). In some aspects, the network node may apply a reduced power based at least in part on reducing an output power of a transmission antenna array and/or increasing a beam width used to transmit the additional communication, among other examples.

Based at least in part on reducing saturation of the one or more reception components of the UE, the UE may support an increased MCS, which may conserve network resources, and the network node may conserve power resources that may have otherwise been used to increase transmission power in an attempt to increase the MCS.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with an indication (e.g., a request) indication to reduce transmission power.

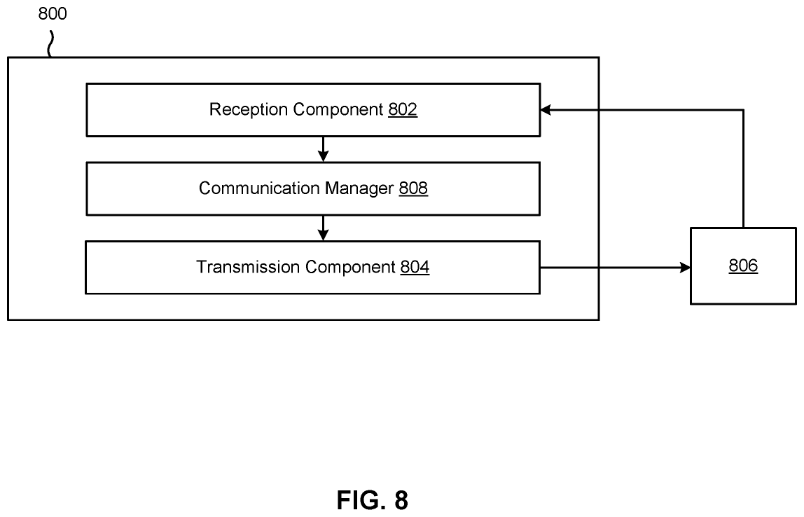

As shown in FIG. 6, in some aspects, process 600 may include receiving a communication with a received power that satisfies a threshold (block 610). For example, the UE (e.g., using reception component 802 and/or communication manager 806, depicted in FIG. 8) may receive a communication with a received power that satisfies a threshold, as described above.

As further shown in FIG. 6, in some aspects, process 600 may include transmitting an indication (e.g., a request) indication to reduce a transmission power based at least in part on the received power satisfying the threshold (block 620). For example, the UE (e.g., using transmission component 804 and/or communication manager 806, depicted in FIG. 8) may transmit an indication (e.g., a request) indication to reduce a transmission power based at least in part on the received power satisfying the threshold, as described above.

Process 600 may include additional aspects, such as any single aspect or any combination of aspects described below and/or in connection with one or more other processes described elsewhere herein.

In a first aspect, process 600 includes receiving one or more of an indication of a time domain resource at which an additional communication is to be transmitted with a reduced transmission power, or the additional communication with a reduced received power based at least in part on the indication to reduce the transmission power.

In a second aspect, alone or in combination with the first aspect, the additional communication is to be transmitted with the reduced transmission power based at least in part on one or more of an output power of a transmission antenna array, or a beam width used to transmit the additional communication.

In a third aspect, alone or in combination with one or more of the first and second aspects, the threshold is associated with a saturation of a reception component.

In a fourth aspect, alone or in combination with one or more of the first through third aspects, saturation of the reception component is associated with support for a reduced MCS relative to an MCS that is supported when the reception component is not saturated.

In a fifth aspect, alone or in combination with one or more of the first through fourth aspects, the communication comprises one or more of an optical wireless communication-based communication, an extended-reality-based communication, or an Internet-of-Things-based communication.

In a sixth aspect, alone or in combination with one or more of the first through fifth aspects, the UE comprises one or more of an extended reality display device or input device, an optical wireless communication device, an Internet of Things device, a device with limited capability for an ADC a device with limited capability for ENOB, or a device with limited capability for AGC.

In a seventh aspect, alone or in combination with one or more of the first through sixth aspects, the indication to reduce the transmission power indicates an amount of a reduction of transmission power relative to a transmission power used for transmitting the communication.

In an eighth aspect, alone or in combination with one or more of the first through seventh aspects, the amount of the reduction has a granularity that is based at least in part on one or more of a configuration received from a network node, or a communication protocol.

In a ninth aspect, alone or in combination with one or more of the first through eighth aspects, the indication to reduce the transmission power is associated with one or more of a component carrier, a beam used to transmit the communication, a beam width, a channel, or a MCS.

In a tenth aspect, alone or in combination with one or more of the first through ninth aspects, process 600 includes transmitting an indication of one or more of supporting for transmitting the indication to reduce the transmission power, a risk for reduced MCS when receiving communications with received powers that satisfy the threshold, or one or more parameters of an AGC of the UE.

In an eleventh aspect, alone or in combination with one or more of the first through tenth aspects, process 600 includes receiving an indication of one or more of reception of the indication to reduce the transmission power, or an AGC configuration for the UE to use for receiving communications.

In a twelfth aspect, alone or in combination with one or more of the first through eleventh aspects, transmitting the indication to reduce the transmission power comprises transmitting the indication via one or more of MAC signaling, RRC signaling, or a CSI report.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with indication to reduce transmission power.

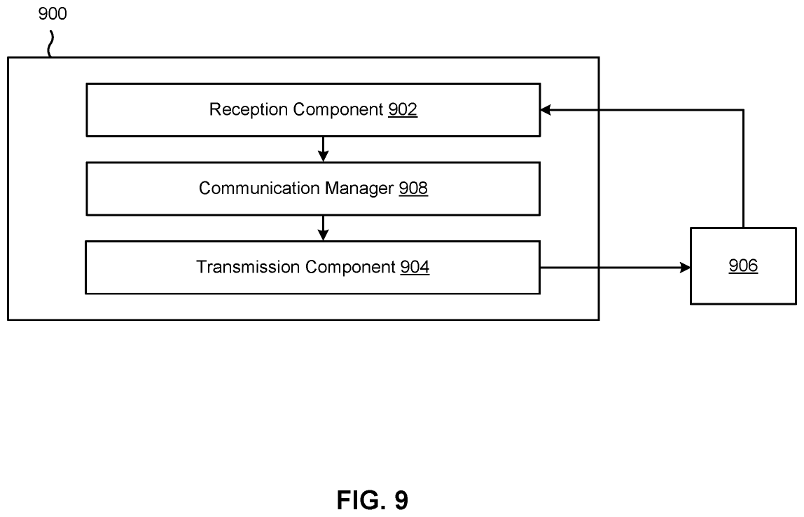

As shown in FIG. 7, in some aspects, process 700 may include transmitting a first communication with a first transmission power (block 710). For example, the network node (e.g., using transmission component 904 and/or communication manager 906, depicted in FIG. 9) may transmit a first communication with a first transmission power, as described above.

As further shown in FIG. 7, in some aspects, process 700 may include receiving an indication (e.g., a request) indication to reduce a transmission power based at least in part on a received power, at a UE, satisfying a threshold (block 720). For example, the network node (e.g., using reception component 902 and/or communication manager 906, depicted in FIG. 9) may receive an indication (e.g., a request) indication to reduce a transmission power based at least in part on a received power, at a UE, satisfying a threshold, as described above.

As further shown in FIG. 7, in some aspects, process 700 may include transmitting a second communication with a second transmission power that is less than the first transmission power (block 730). For example, the network node (e.g., using transmission component 904 and/or communication manager 906, depicted in FIG. 9) may transmit a second communication with a second transmission power that is less than the first transmission power, as described above.

Process 700 may include additional aspects, such as any single aspect or any combination of aspects described below and/or in connection with one or more other processes described elsewhere herein.

In a first aspect, process 700 includes transmitting, before transmitting the second communication, an indication of a time domain resource at which the second communication is to be transmitted with the second transmission power.

In a second aspect, alone or in combination with the first aspect, the second communication is transmitted with the second transmission power based at least in part on one or more of a reduction of an output power of a transmission antenna array, or an increase of a beam width used to transmit the second communication.

In a third aspect, alone or in combination with one or more of the first and second aspects, the threshold is associated with a saturation of a reception component of the UE.

In a fourth aspect, alone or in combination with one or more of the first through third aspects, saturation of the reception component of the UE is associated with support for a reduced MCS relative to an MCS that is supported when the reception component is not saturated.

In a fifth aspect, alone or in combination with one or more of the first through fourth aspects, the communication comprises one or more of an optical wireless communication-based communication, an extended-reality-based communication, or an Internet-of-Things-based communication.

In a sixth aspect, alone or in combination with one or more of the first through fifth aspects, process 700 includes receiving an indication that the UE comprises one or more of an extended reality display device or input device, an optical wireless communication device, an Internet of Things device, a device with limited capability for an ADC a device with limited capability for ENOB, or a device with limited capability for AGC.

In a seventh aspect, alone or in combination with one or more of the first through sixth aspects, the indication to reduce the transmission power indicates an amount of a reduction of transmission power relative to the first transmission power.

In an eighth aspect, alone or in combination with one or more of the first through seventh aspects, the amount of the reduction has a granularity that is based at least in part on one or more of a configuration transmitted to the UE, or a communication protocol.

In a ninth aspect, alone or in combination with one or more of the first through eighth aspects, the indication to reduce the transmission power is associated with one or more of a component carrier, a beam used to transmit the communication, a beam width, a channel, or a MCS.

In a tenth aspect, alone or in combination with one or more of the first through ninth aspects, process 700 includes receiving an indication of one or more of supporting for transmitting the indication to reduce the transmission power, a risk for reduced MCS when receiving communications with received powers that satisfy the threshold, or one or more parameters of an AGC of the UE.

In an eleventh aspect, alone or in combination with one or more of the first through tenth aspects, process 700 includes transmitting an indication of one or more of reception of the indication to reduce transmission power, or an AGC configuration for the UE to use for receiving communications.

In a twelfth aspect, alone or in combination with one or more of the first through eleventh aspects, receiving the indication to reduce the transmission power comprises transmitting the indication via one or more of MAC signaling, RRC signaling, or a CSI report.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive a communication with a received power that satisfies a threshold. The transmission component 804 may transmit an indication (e.g., a request) indication to reduce a transmission power based at least in part on the received power satisfying the threshold.

The reception component 802 may receive one or more of an indication of a time domain resource at which an additional communication is to be transmitted with a reduced transmission power, or the additional communication with a reduced received power based at least in part on the indication to reduce the transmission power.

The transmission component 804 may transmit an indication of one or more of support for transmitting the indication to reduce the transmission power, a risk for reduced MCS when receiving communications with received powers that satisfy the threshold, or one or more parameters of an AGC of the UE.

The reception component 802 may receive an indication of one or more of reception of the indication to reduce the transmission power, or an AGC configuration for the UE to use for receiving communications.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit a first communication with a first transmission power. The reception component 902 may receive an indication (e.g., a request) indication to reduce a transmission power based at least in part on a received power, at a UE, satisfying a threshold. The transmission component 904 may transmit a second communication with a second transmission power that is less than the first transmission power.

The transmission component 904 may transmit, before transmitting the second communication, an indication of a time domain resource at which the second communication is to be transmitted with the second transmission power.

The reception component 902 may receive an indication that the UE comprises one or more of an extended reality display device or input device, an optical wireless communication device, an Internet of Things device, a device with limited capability for an ADC a device with limited capability for ENOB, or a device with limited capability for AGC.

The reception component 902 may receive an indication of one or more of support for transmitting the indication to reduce the transmission power, a risk for reduced MCS when receiving communications with received powers that satisfy the threshold, or one or more parameters of an AGC of the UE.

The transmission component 904 may transmit an indication of one or more of reception of the indication to reduce transmission power, or an AGC configuration for the UE to use for receiving communications.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving a communication with a received power that satisfies a threshold; and transmitting a request to reduce a transmission power based at least in part on the received power satisfying the threshold.

Aspect 2: The method of Aspect 1, further comprising receiving one or more of: an indication of a time domain resource at which an additional communication is to be transmitted with a reduced transmission power, or the additional communication with a reduced received power based at least in part on the request to reduce the transmission power.

Aspect 3: The method of Aspect 2, wherein the additional communication is to be transmitted with the reduced transmission power based at least in part on one or more of: an output power of a transmission antenna array, or a beam width used to transmit the additional communication.

Aspect 4: The method of any of Aspects 1-3, wherein the threshold is associated with a saturation of a reception component or a maximum throughput for communications with the UE.

Aspect 5: The method of Aspect 4, wherein saturation of the reception component is associated with support for a reduced modulation and coding scheme (MCS) relative to an MCS that is supported when the reception component is not saturated.

Aspect 6: The method of any of Aspects 1-5, wherein the communication comprises one or more of: an optical wireless communication-based communication, an extended-reality-based communication, or an Internet-of-Things-based communication.

Aspect 7: The method of any of Aspects 1-6, wherein the UE comprises one or more of: an extended reality display device or input device, an optical wireless communication device, an Internet of Things device, a device with limited capability for an analog to digital converter (ADC) a device with limited capability for effective number of bits (ENOB), or a device with limited capability for automatic gain control (AGC).

Aspect 8: The method of any of Aspects 1-7, wherein the request to reduce the transmission power indicates an amount of a reduction of transmission power relative to a transmission power used for transmitting the communication.

Aspect 9: The method of Aspect 8, wherein the amount of the reduction has a granularity that is based at least in part on one or more of: a configuration received from a network node, or a communication protocol.

Aspect 10: The method of any of Aspects 1-9, wherein the request to reduce the transmission power is associated with one or more of: a component carrier, a beam used to transmit the communication, a beam width, a channel, or a modulation and coding scheme (MCS).

Aspect 11: The method of any of Aspects 1-10, further comprising transmitting an indication of one or more of: support for transmitting the request to reduce the transmission power, a risk for reduced modulation and coding scheme (MCS) when receiving communications with received powers that satisfy the threshold, or one or more parameters of an automatic gain control (AGC) of the UE.

Aspect 12: The method of Aspect 11, further comprising receiving an indication of one or more of: reception of the request to reduce the transmission power, or an AGC configuration for the UE to use for receiving communications.

Aspect 13: The method of any of Aspects 1-12, wherein transmitting the request to reduce the transmission power comprises transmitting the indication via one or more of: medium access control (MAC) signaling, radio resource control (RRC) signaling, or a channel state information (CSI) report.

Aspect 14: A method of wireless communication performed by a network node, comprising: transmitting a first communication with a first transmission power; receiving an indication to reduce a transmission power based at least in part on a received power, at a user equipment (UE), satisfying a threshold; and transmitting a second communication with a second transmission power that is less than the first transmission power.

Aspect 15: The method of Aspect 14, further comprising: transmitting, before transmitting the second communication, an indication of a time domain resource at which the second communication is to be transmitted with the second transmission power.

Aspect 16: The method of Aspect 15, wherein the second communication is transmitted with the second transmission power based at least in part on one or more of: a reduction of an output power of a transmission antenna array, or an increase of a beam width used to transmit the second communication.

Aspect 17: The method of any of Aspects 14-16, wherein the threshold is associated with a saturation of a reception component or a maximum throughput for communications with the UE of the UE.

Aspect 18: The method of Aspect 17, wherein saturation of the reception component of the UE is associated with support for a reduced modulation and coding scheme (MCS) relative to an MCS that is supported when the reception component is not saturated.

Aspect 19: The method of any of Aspects 14-18, wherein the communication comprises one or more of: an optical wireless communication-based communication, an extended-reality-based communication, or an Internet-of-Things-based communication.

Aspect 20: The method of any of Aspects 14-19, further comprising receiving an indication that the UE comprises one or more of: an extended reality display device or input device, an optical wireless communication device, an Internet of Things device, a device with limited capability for an analog to digital converter (ADC) a device with limited capability for effective number of bits (ENOB), or a device with limited capability for automatic gain control (AGC).

Aspect 21: The method of any of Aspects 14-20, wherein the request to reduce the transmission power indicates an amount of a reduction of transmission power relative to the first transmission power.

Aspect 22: The method of Aspect 21, wherein the amount of the reduction has a granularity that is based at least in part on one or more of: a configuration transmitted to the UE, or a communication protocol.

Aspect 23: The method of any of Aspects 14-22, wherein the request to reduce the transmission power is associated with one or more of: a component carrier, a beam used to transmit the communication, a beam width, a channel, or a modulation and coding scheme (MCS).

Aspect 24: The method of any of Aspects 14-23, further comprising receiving an indication of one or more of: support for transmitting the request to reduce the transmission power, a risk for reduced modulation and coding scheme (MCS) when receiving communications with received powers that satisfy the threshold, or one or more parameters of an automatic gain control (AGC) of the UE.

Aspect 25: The method of Aspect 24, further comprising transmitting an indication of one or more of: reception of the request to reduce transmission power, or an AGC configuration for the UE to use for receiving communications.

Aspect 26: The method of any of Aspects 14-25, wherein receiving the request to reduce the transmission power comprises transmitting the indication via one or more of: medium access control (MAC) signaling, radio resource control (RRC) signaling, or a channel state information (CSI) report.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a communication with a received power that satisfies a threshold; and
transmit a request to reduce a transmission power based at least in part on the received power satisfying the threshold.

2. The UE of claim 1, wherein the one or more processors are further configured to receive one or more of:
an indication of a time domain resource at which an additional communication is to be transmitted with a reduced transmission power, or
the additional communication with a reduced received power based at least in part on the request to reduce the transmission power.

3. The UE of claim 2, wherein the additional communication is to be transmitted with the reduced transmission power based at least in part on one or more of:
an output power of a transmission antenna array, or
a beam width used to transmit the additional communication.

4. The UE of claim 1, wherein the threshold is associated with one or more of:
a saturation of a reception component, or
a maximum throughput for communications with the UE.

5. The UE of claim 4, wherein saturation of the reception component is associated with support for a reduced modulation and coding scheme (MCS) relative to an MCS that is supported when the reception component is not saturated, or
wherein the maximum throughput for communications with the UE is based at least in part on one or more of the saturation of the reception component, a rank of communications, or the received power.

6. The UE of claim 1, wherein the communication comprises one or more of:
an optical wireless communication-based communication,
an extended-reality-based communication, or
an Internet-of-Things-based communication.

7. The UE of claim 1, wherein the UE comprises one or more of:
an extended reality display device or input device,
an optical wireless communication device,
an Internet of Things device,
a device with limited capability for an analog to digital converter (ADC)
a device with limited capability for effective number of bits (ENOB), or
a device with limited capability for automatic gain control (AGC).

8. The UE of claim 1, wherein the request to reduce the transmission power indicates an amount of a reduction of transmission power relative to a transmission power used for transmitting the communication.

9. The UE of claim 8, wherein the amount of the reduction has a granularity that is based at least in part on one or more of:
a configuration received from a network node, or
a communication protocol.

10. The UE of claim 1, wherein the request to reduce the transmission power is associated with one or more of:
a component carrier,
a beam used to transmit the communication,
a beam width,
a channel, or
a modulation and coding scheme (MCS).

11. The UE of claim 1, wherein the one or more processors are further configured to transmit an indication of one or more of:
support for transmitting the request to reduce the transmission power,
a risk for reduced modulation and coding scheme (MCS) when receiving communications with received powers that satisfy the threshold, or
one or more parameters of an automatic gain control (AGC) of the UE.

12. The UE of claim 11, wherein the one or more processors are further configured to receive an indication of one or more of:
reception of the request to reduce the transmission power, or
an AGC configuration for the UE to use for receiving communications.

13. The UE of claim 1, wherein the one or more processors, to transmit the request to reduce the transmission power, are configured to transmit the indication via one or more of:
medium access control (MAC) signaling,
radio resource control (RRC) signaling, or
a channel state information (CSI) report.

14. A network node for wireless communication, comprising:
a memory; and
one or more processors, coupled to the memory, configured to:
transmit a first communication with a first transmission power;
receive a request to reduce a transmission power based at least in part on a received power, at a user equipment (UE), satisfying a threshold; and
transmit a second communication with a second transmission power that is less than the first transmission power.

15. The network node of claim 14, wherein the one or more processors are further configured to:
transmit, before transmitting the second communication, an indication of a time domain resource at which the second communication is to be transmitted with the second transmission power.

16. The network node of claim 15, wherein the second communication is transmitted with the second transmission power based at least in part on one or more of:
a reduction of an output power of a transmission antenna array, or
an increase of a beam width used to transmit the second communication.

17. The network node of claim 14, wherein the threshold is associated with one or more of:
a saturation of a reception component of the UE, or
a maximum throughput for communications with the UE.

18. The network node of claim 17, wherein saturation of the reception component of the UE is associated with support for a reduced modulation and coding scheme (MCS) relative to an MCS that is supported when the reception component is not saturated.

19. The network node of claim 14, wherein the communication comprises one or more of:
an optical wireless communication-based communication,
an extended-reality-based communication, or
an Internet-of-Things-based communication.

20. The network node of claim 14, wherein the one or more processors are further configured to receive an indication that the UE comprises one or more of:
an extended reality display device or input device,
an optical wireless communication device,
an Internet of Things device,
a device with limited capability for an analog to digital converter (ADC)
a device with limited capability for effective number of bits (ENOB), or
a device with limited capability for automatic gain control (AGC).

21. The network node of claim 14, wherein the request to reduce the transmission power indicates an amount of a reduction of transmission power relative to the first transmission power.

22. The network node of claim 21, wherein the amount of the reduction has a granularity that is based at least in part on one or more of:
a configuration transmitted to the UE, or
a communication protocol.

23. The network node of claim 14, wherein the request to reduce the transmission power is associated with one or more of:
a component carrier,
a beam used to transmit the communication,
a beam width,
a channel, or
a modulation and coding scheme (MCS).

24. The network node of claim 14, wherein the one or more processors are further configured to receive an indication of one or more of:
support for transmitting the request to reduce the transmission power,
a risk for reduced modulation and coding scheme (MCS) when receiving communications with received powers that satisfy the threshold, or
one or more parameters of an automatic gain control (AGC) of the UE.

25. The network node of claim 24, wherein the one or more processors are further configured to transmit an indication of one or more of:
reception of the request to reduce transmission power, or
an AGC configuration for the UE to use for receiving communications.

26. The network node of claim 14, wherein the one or more processors, to receive the request to reduce the transmission power, are configured to transmit the indication via one or more of:
medium access control (MAC) signaling,
radio resource control (RRC) signaling, or
a channel state information (CSI) report.

27. A method of wireless communication performed by a user equipment (UE), comprising:
receiving a communication with a received power that satisfies a threshold; and
transmitting a request to reduce a transmission power based at least in part on the received power satisfying the threshold.

28. The method of claim 27, wherein the threshold is associated with one or more of:
a saturation of a reception component, or
a maximum throughput for communications with the UE.

29. A method of wireless communication performed by a network node, comprising:
transmitting a first communication with a first transmission power;
receiving a request to reduce a transmission power based at least in part on a received power, at a user equipment (UE), satisfying a threshold; and
transmitting a second communication with a second transmission power that is less than the first transmission power.

30. The method of claim 14, wherein the threshold is associated with one or more of:
a saturation of a reception component of the UE, or
a maximum throughput for communications with the UE.
